(19) United States
(12) Patent Application Publication
(10) Pub. No.: US 2012/0144308 A1
(43) Pub. Date: Jun. 7, 2012

(54) SYSTEM AND METHOD FOR RECOMMENDING DIGITAL CONTENT USING CONTACTS LISTS

(76) Inventors: Bharat Welingkar, Los Altos, CA (US); Thorsten Kuehnemund, Redmond City, CA (US); Jaireh Tecarro, San Francisco, CA (US); Patrick Hetroy, Palo Alto, CA (US)

(21) Appl. No.: 13/269,484

(22) Filed: Oct. 7, 2011

Related U.S. Application Data
(60) Provisional application No. 61/406,978, filed on Oct. 26, 2010.

(51) Int. Cl. G06F 3/01; G06F 15/16

(52) U.S. Cl. 715/738

(57) ABSTRACT

A system and method for recommending digital content in which a user employs her contacts list to recommend the digital content. The recommender initiates the recommendation process using her local device by generating a recommendation. The recommendation contains an identification of the recommender, an identification of the contact and an identification of the digital content to be recommended. The recommendation is communicated from the recommender's local device through a communication channel to a server. The server processes the recommendation from the recommender and generates a recommendation email and/or a recommendation notification. The recommendation email and notification are sent to the recommendee through a communication channel selected by the recommender. The recommendation email further contains a URL that directs the recommendee back to a summary of the recommended digital content.

### CROSS REFERENCE TO RELATED APPLICATION

This application claims benefit under 35 U.S.C. §119(e) from U.S. Provisional Patent application No. 61/406,978, filed on Oct. 26, 2010, the entirety of which is incorporated by reference herein.

### FIELD OF THE INVENTION

The present invention generally relates to systems and methods for recommending digital content, and more particularly to systems and methods for recommending digital content using a user's contacts list.

### SUMMARY OF THE INVENTION

The system of the present invention is used for controlling distribution and use of digital content. In a preferred embodiment, the digital content is electronic books (eBooks). The system and method of the present invention enables the owner/reader of an eBook to recommend the book to another user. Preferably, the other user is already a registered user of the system and is able to access/purchase the eBook directly through the system. In one embodiment, the recommender selects the recommendee through her contacts list on the system. The system is then able to send a message to the recommendee notifying him of the recommendation.

If the recommendee is already a registered user of the system, the system sends him a system internal notification and optionally an email notification. The email address of the recommendee is extracted from the recommender's contact list. If the recommendee is not a registered user of the system, the system only sends him an email notification. The email notification containing the recommendation preferably contains a link, Uniform Resource Locator (URL), that will lead the recommendee back to the system where he can become a registered user and gain access to the recommended digital content, e.g., by purchasing the content (e.g., an eBook). In a preferred embodiment, the URL links the recommendee to a detailed summary of the recommended material, e.g., eBook, contained on the system.

In an alternative embodiment, the recommender can make the recommendation through a social network, such as Facebook™ or Twitter™. Again, the recommender can select the recommendee via her contacts list and can additionally choose to send the recommendation notice via the social network. Prior to the recommendation, the recommender has authorized the system to act on her behalf when interacting with these social networks. When the recommender makes the recommendation, the system logs onto the applicable social network as the recommender and posts the recommendation. Specifically with respect to Facebook™, the system has the recommendee's Facebook™ user ID, and is thus able to post the recommendation on the recommendee's wall as a news feed from the recommender.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a system and data flow according to the present invention;

FIG. 2A-2D depict a process of making a recommendation via email;

FIG. 3 illustrates a recommendation email;

FIG. 4 depicts a digital content control server;

FIG. 5 illustrates a flowchart for a process of making a recommendation;

FIGS. 6A-6D illustrate a process of making a recommendation via Facebook™; and

FIGS. 7A-7D illustrate a process of making a recommendation via Twitter™.

### DETAILED DESCRIPTION OF THE INVENTION

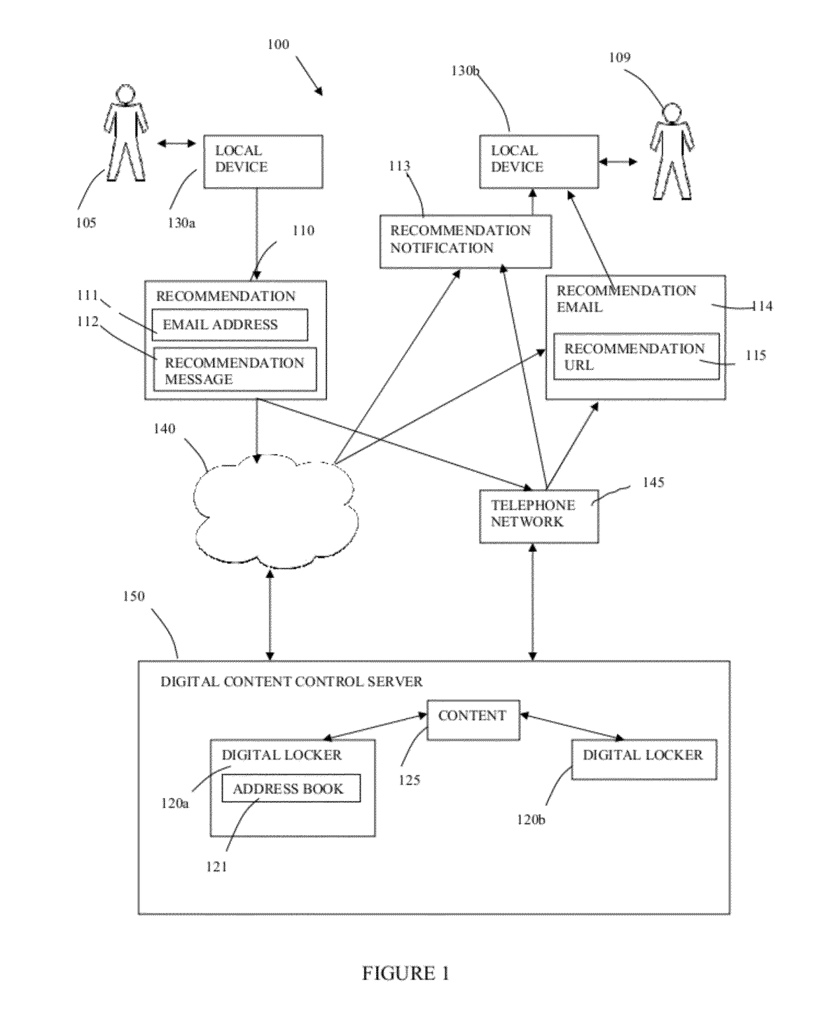

FIG. 1 shows components of digital content control system 100 according to the present invention. Recommender 105 is an authorized user of digital content control system 100 and uses her local device 130a to facilitate her recommendation of her digital content. Many of the functions of digital content control system 100 of the present invention are carried out on digital content control server 150. As appreciated by those skilled in the art, many of the functions described herein can be divided between the digital content control server 150 and the user's local device 130a. Further, as also appreciated by those skilled in the art, digital content control server 150 can be considered a “cloud” with respect to the user and her local device 130a. The cloud can actually be comprised of several servers performing interconnected and distributed functions. For the sake of simplicity in the present discussion, only a single server 150 will be described. The recommender 105 can connect to the digital content control server 150 via the Internet 140, a telephone network 145 (e.g., wirelessly through a cellphone network) or other suitable electronic communication means. Recommender 105 has an account on digital content control server 150, which authorizes recommender 105 to use digital content control system 100.

Associated with the recommender's 105 account, is the recommender's 105 digital locker 120a located on the digital content control server 150. As further described below, in the preferred embodiment, digital locker 120a contains links to copies of digital content 125 previously purchased (or otherwise legally acquired) by recommender 105.

Indicia of rights to all copies of digital content 125 owned by recommender 105, including digital content 125, is stored by reference in digital locker 120a. Digital locker 120a is a remote online repository that is uniquely associated with the recommender's 105 account. As appreciated by those skilled in the art, the actual copies of the digital content 125 are not necessarily stored in the user's locker 120a, but rather the locker 120a stores an indication of the rights of the user to the particular content 125 and a link or other reference to the actual digital content 125. Typically, the actual copy of the digital content 125 is stored in another mass storage (not shown). The digital lockers 120 of all of the recommenders 105 who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the digital content control server can contain millions of files 125 containing digital content. It is also contemplated that the digital content control server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

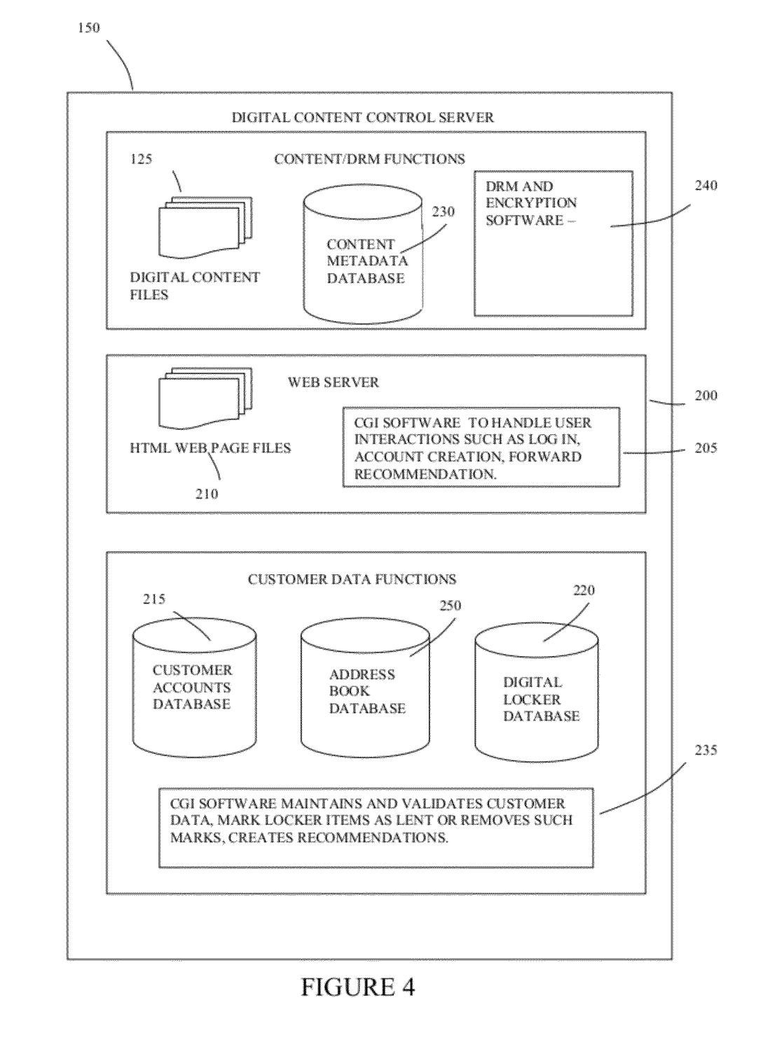

Also contained in the recommender's digital locker 120a is her address book 121, i.e., her contacts list. As described further below in connection with FIG. 4, the actual contacts can be stored in an Address Book Database 250. As with traditional address books, the address book 121 of the present invention contains the contact's name and email addresses. The address book 121 is capable of storing multiple email addresses for each contact. In addition, the address book 121 contains an indication of whether the contact is also an authorized (registered) user of the system 100 with his own account on server 150. The address book also contains the social network user IDs of the contacts (e.g., their Facebook™ user IDs).

Recommender 105 can access his or her digital locker 120a using a local device 130a. Local device 130a is an electronic device such as a personal computer, an e-book reader, a smart phone or other electronic device that the recommender 105 can use to access the digital content control server 150. In a preferred embodiment, the local device has been previously associated (registered) with the recommender's 105 account using recommender's 105 account credentials. Local device 130a provides the capability for recommender 105 to download recommender's 105 copy of digital content 125 via his or her digital locker 120a. After digital content 125 is downloaded to local device 130a, recommender 105 can engage with the downloaded content locally, e.g., read the book, listen to the music or watch the video.

In a preferred embodiment, local device 130a includes a non-browser based device recommendation interface that allows recommender 105 to initiate the recommendation of digital content 125 to another authorized user of digital content control system 100 in a non-browser environment. Through the device recommendation interface, the recommender 105 is automatically connected to the digital content control server 150 in a non-browser based environment. This connection to the digital content control server is a secure interface and can be through the telephone network 145, typically a cellular network for mobile devices. If recommender 105 is accessing his or her digital locker 120 using the Internet 140, local device 130a also includes a web account interface. Web account interface provides recommender 105 with browser-based access to his or her account and digital locker 120 over the Internet 140. The web account interface also includes web recommendation interface similar to the device recommendation interface of the non-browser embodiment. Web recommendation interface allows recommender 105 to initiate the recommendation of digital content 125 to another authorized user of digital content control system 100 in a browser based environment.

Recommendee 109 is also preferably an authorized user of digital content control system 100. As with recommender 105, recommendee 109 has account with digital content control server 150, which authorizes recommendee 109 to use digital content control system 100. As with recommender 105, recommendee 109 can access his digital locker 120b using his local device 130b. In a preferred embodiment, local device 130b is a device that recommendee 109 has previously associated (registered) with his account using recommendee's 109 account credentials. Local device 130b allows recommendee 109 to view a summary of the recommended digital content 125 on digital content control server 150.

Recommendee 109 can also access his digital locker 120b using a browser based web account interface. Web account interface provides recommendee 109 with browser-based access to his account and digital locker 120b over the Internet 140. Web account interface also provides recommendee 109 with access to the web recommendation interface. Web recommendation interface allows recommendee 109 to respond to recommendation emails.

As shown in FIG. 1, recommender 105 initiates an recommendation 110 to recommend digital content 125 to recommendee 109. As further described below, when processed by the digital content control server 150, a recommendation 110 initiated by recommender 105 is linked to a summary of the digital content 125 that is being recommended.

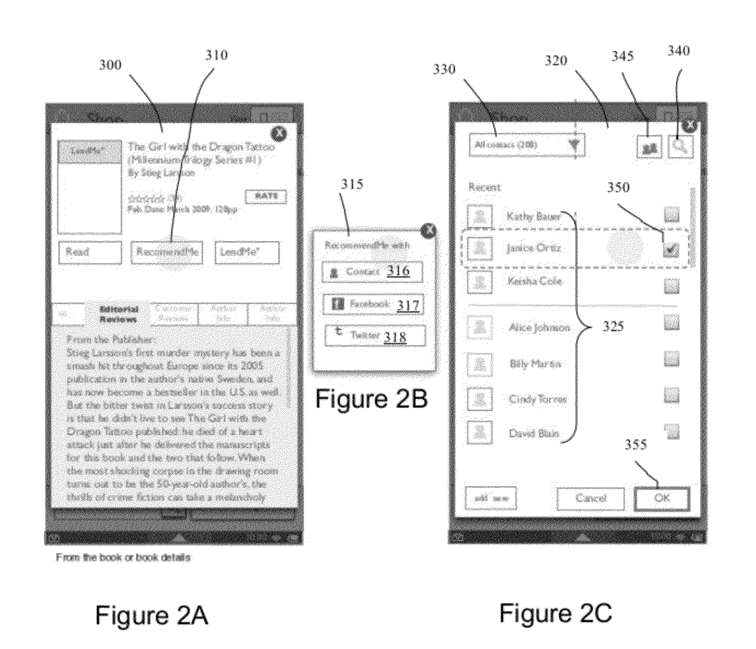

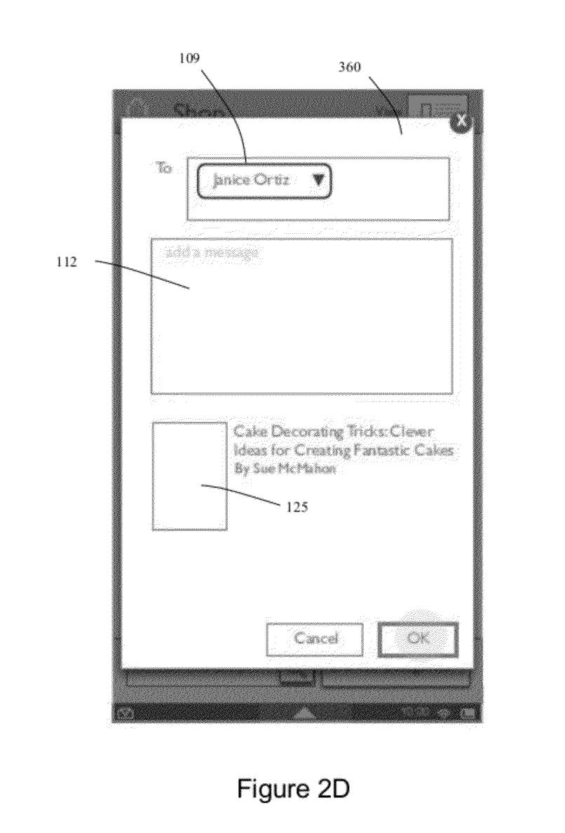

The process of making a recommendation via email is illustrated in FIG. 2A-2D. Although recommender 105 can initiate the recommendation process from several applications in her local device 130a, a typical place is when the recommender 105 is actually viewing particular book 125. As shown in FIG. 2A, a user interface 300 contains a detailed summary of a book 125 owned by recommender 105 and includes a ‘Recommend Me’ button 310. If recommender taps (clicks) on the Recommend Me button 310, the system presents the user with a pop-up box 315 as illustrated in FIG. 2B and prompts the user for which communication method she wants to make her recommendation. Box 315, in the example illustrated in FIG. 2B, provides the user with the choices of making the recommendation via her contacts list 316, Facebook™ 317 or Twitter™ 318. As understood by those skilled in the art, other networks, including other social networks can be used to communicate a recommendation.

As shown in FIGS. 2B-2C, if the user taps on “Contacts” 316 in pop up box 315, the system will bring up a user interface 320 that displays the user's contact list as illustrated in FIG. 2C. Recommender 105 is able to scroll and search her list of contacts 325 to find the particular contact to which she wants to extend the recommendation. Recommender 105 can use dropdown box 330 to filter her contacts according to predefined criteria. The search button 340 can be used to search for specific contacts 325. Button 345 is an icon for the user's groups or friends. Tapping on button 345 will show all the user's contacts that also have accounts on server 150. Recommender 105 uses button 350 to select the particular contact to which she would like to send the recommendation 110 and clicks the OK button 355 to make the selection and proceed with the process of making the recommendation 110 of book 125 to the selected contact.

As shown in FIG. 2D, after a particular contact has been chosen from user interface 320 (FIG. 2C), the recommendee 109 and the book 125 to be recommended are displayed on user interface 360. Interface 360 allows the recommender 105 to confirm both the identity of the recommendee 109 and the book 125 before the recommendation is sent. Further, the recommender 105 can type a personal message 112 (e.g., ‘I know you'll love this book’) that will be included in the email 114 containing the recommendation 110.

Returning to FIG. 1, the recommendation 110 may include informational details about the loaned content 125 and recommender 105, such as the title of the item 125 and the name of recommender 105. Recommendation 110 preferably includes an email address 111 of recommendee 109 and a recommendation message 112. The email address 111 is an unconfirmed email address of recommendee 109 that is retrieved from recommender's address book. Recommendation message 112 contains content (e.g., recommendee's 109 email address) that is used to communicate the recommendation 110 to recommendee 109. Recommendation message 112 may also include the optional message content entered by recommender 105 as described above.

In the non-browser embodiment, email address 111 is used by the digital content control server 150 to identify the recommendee 109 in the system in order to deliver a recommendation notification 113 to recommendee 109 on local device 130b. In order to receive recommendation notification 113, recommendee 109 must be an authorized user of server 150. The recommendation notification 113 will be received by the recommendee 109 the next time he logs onto his account on the digital content control server 150. Recommendation notification 113 is an alert delivered by digital content control system 150 to recommendee 109 which recommendee 109 receives and can respond to using device recommendation interface in his local device 130b. Recommendation email 114 is an email delivered to email address 111 that recommendee 109 receives via his email system.

Email address 111 is also used to deliver recommendation email 114 directly to recommendee's 109 email account. Recommendation email 114 can be sent to either authorized user of lending server 150, or people who have never been affiliated with server 150. The recommendee 109 can respond to the recommendation email 114 via a Uniform Resource Locator (URL) contained in the recommendation email 114.

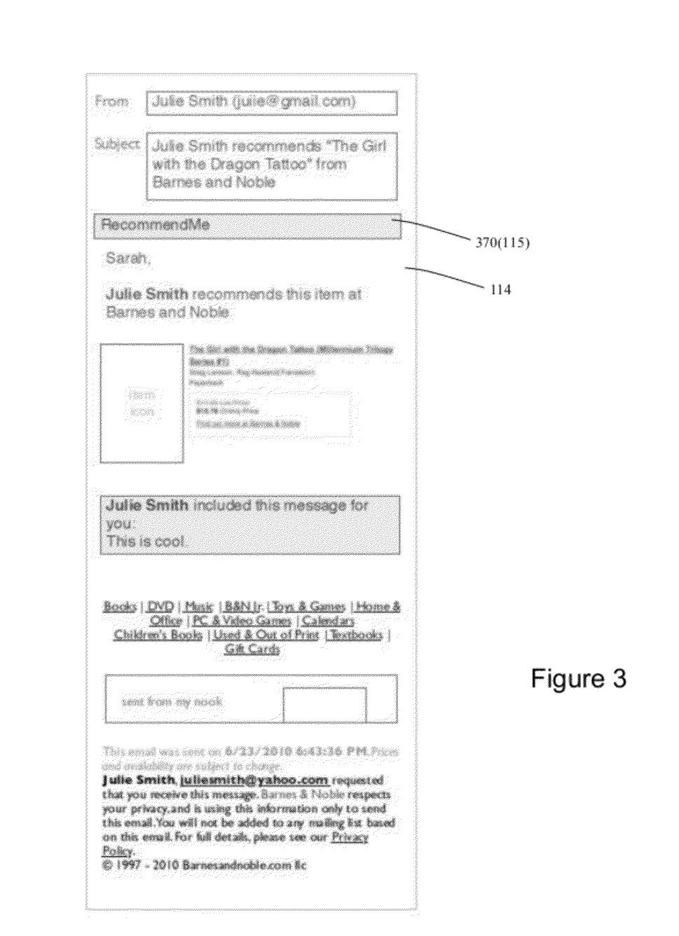

FIG. 3 illustrates a recommendation email 114 that is sent by server 150 and received by recommendee 109 on his email system. Recommendation email 114 contains a recommendation Uniform Resource Locator (URL). Recommendation URL 115 can be embedded in several selectable areas in the email 114, such as a dedicated button 370. URL 115 preferably links the recommendee 109 to the summary of the recommended eBook on server 150.

Returning again to FIG. 1, digital content control server 150 manages the receipt of the recommendation 110 from recommender 105 and initiates the generation and delivery of recommendation notification 113, and recommendation email 114 to recommendee 109. Digital content control server 150 is also capable of receiving a recommendation 110 from recommender 105 that is intended for a proposed recommendee that is not already an authorized user of the system (i.e. recommendee does not have an account established on digital content control server 150). In this embodiment of the present invention, digital content control server 150 only sends the recommendation email 114 to the proposed recommendee, and does not send a notification 113 (since the notification 113 is only sent to registered users of the system).

Similar to the email recommendation process described above, the system 100 of the present invention is also able to communicate recommendations via other networks, such as a social network. For example, if one of recommender's 105 contacts is indicated in recommender's address book as having a Facebook™ user ID, when the recommender 105 selects this recommendee to extend a recommendation via Facebook™, the system is capable of creating a feed story on Facebook™ directed at the selected recommendee 109. Prior to the recommendation, the recommender has authorized the system to act on her behalf when interacting with these social networks. When the recommender makes the recommendation, the system logs onto the applicable social network as the recommender and posts the recommendation. Specifically with respect to Facebook™, the system has the recommendee's Facebook™ user ID, and is thus able to post the recommendation on the recommendee's Facebook™ wall as a news feed from the recommender.

The story/message on Facebook™ contains the URL 115 as described above, which allows the recommendee 109 to be directed back to summary of the recommended eBook on server 150. Preferably, if the recommendee 109 is not a registered user of the system, he is invited to become a registered user so that he can purchase the recommended eBook.

FIG. 4 illustrates a block diagram of the detailed components of digital content control server 150. Digital content control server 150 handles front-end functions related to web server operations and user interactions with web and device recommendation interfaces in connection with the user's local devices 130. Digital content control server 150 also handles all backend functions of the system related to managing accounts, maintaining digital locker records, maintaining content metadata, and providing encryption services.

Digital content control server 150 provides both the browser based web recommendation interface and non-browser based device recommendation interface as described above. Recommender 105 may engage with web recommendation interface or device recommendation interface to initiate recommendation 110. Digital content control server 150 uses web recommendation interface as a way to present recommendation 110 to recommendee 109 over the Internet 140. Digital content control server 150 uses the device recommendation interface as a way to present recommendation notification 113 directly to recommendee 109 on local device 130b. Recommendee 109 may engage with web recommendation interface or device recommendation interface to respond to a recommendation 110.

Digital content control server 150 provides access to a web account interface for recommendee 109. Recommendee 109 may log into his account in response to receipt of a recommendation email 114 delivered to email address 111. Digital content control server 150 also provides access to the web account interface to a party with email address 111 who receives recommendation email 114, but does not have an account on digital content control server 150. The non-registered party may use the web account interface to create an account. Creating the account establishes the party as a registered recommendee 109 with an account and a digital locker 120 in digital content control system 100.

Digital content control server 150 employs web server 200 including web services interface software 205 to handle interactions between front-end components, such as device recommendation interface, web account interface, and web recommendation interface, and back-end database components of digital content control system 150. Web server 200 services include serving up the web pages 210 that comprise web account interface and web recommendation interface, and the underlying web services associated with device recommendation interface. Web services interface software 205 includes handling users' logins to their accounts and processing the initiation of and response to recommendation 110.

Back-end database components of digital content control system 100 include customer accounts database 215, digital lockers database 220, Address Book database 250 and content metadata database 230. Records for users' accounts are stored and managed in customer accounts database 215. Records for digital lockers 120 are stored and managed in digital lockers database 220. Content metadata database 230 serves as a source of metadata for individual digital content items 125 in the system.

Web services interface software 205 in the web server 200 interfaces with customer data services 235 to update customer accounts database 215 and digital lockers database 220. Customer data services 235 processes database updates such as maintaining and validating customer data in users' accounts, creating and validating recommendations 110, and sending recommendation notifications 113 and recommendation emails 114.

In the preferred embodiment of the invention, the digital content control system is a consumer-to-consumer eBook digital content control system. Although the eBook application is the preferred embodiment, as appreciated by those skilled in the art, the digital content control system of the present invention is not limited to recommender 105 recommending only an eBook to recommendee 109. Digital content control system can be used for consumer-to-consumer recommendations of any digital content, such as digital movies, digital music, digital audio books, digital pictures, or other downloadable digital content.

In the preferred embodiment of the invention, local devices 130a and 130b are mobile electronic reader (eReader) devices. The embodiment of the invention is not intended to limit local device 130a or local device 130b to a mobile eReader device. Local device 130a or 130b may be a desktop personal computer or another type of mobile consumer electronic device, such as, for example, a cell phone, a laptop computer, a tablet computer or other mobile digital device.

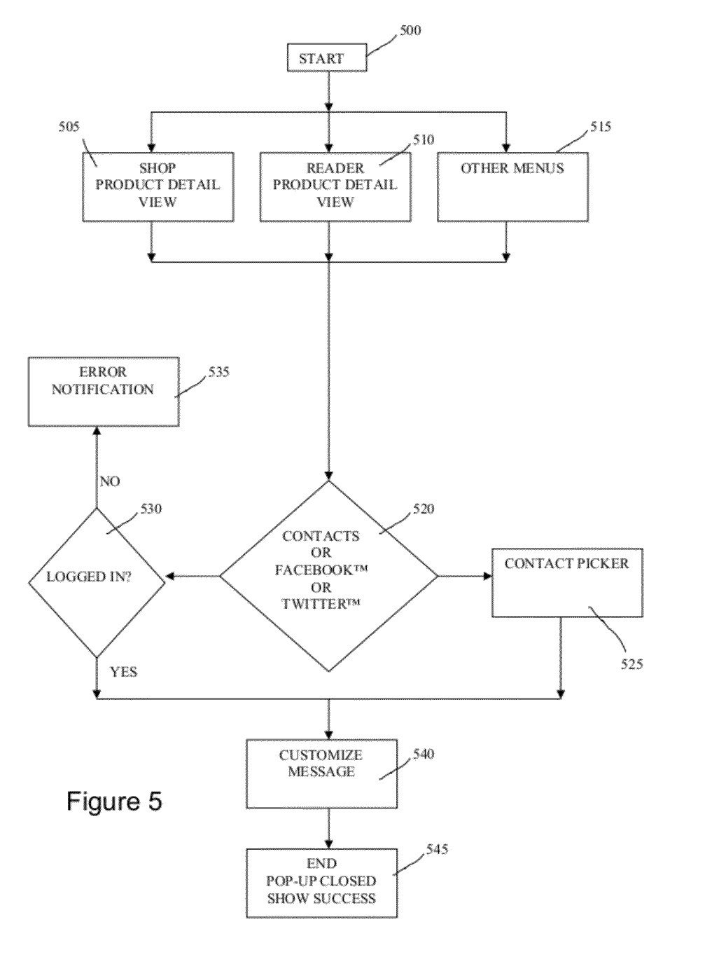

FIG. 5 illustrates a flowchart for the process of making a recommendation. As seen in this Figure, a recommender 105 can initiate 500 a recommendation for a book from several locations. Examples include while the recommender 105 is in a Shopping application 505, while in a Reader application 510 or while in other applications or menus 515 (such as a specific Recommendation or Share menu). After the recommender 105 has chosen a book to recommend, the recommender 105 is then prompted 520 for the mechanism by which she wants to communicate the recommendation. In the embodiment illustrated in FIG. 5, the recommender can use Contacts (email and/or internal system messaging) or the social networks Facebook™ or Twitter™ as described above. As appreciated by those skilled in the art, any other suitable means can be used to communicate the recommendation. Social networks other than Facebook™ or Twitter™ can be used.

If the user selects “Contacts,” the system provides 525 a user interface, as described above, that allows the user to choose the contact and which of the email addresses for the contact to use (or send via the internal messaging system). If the user chooses to communicate the recommendation via a social network, the system verifies 530 that the recommender 105 has authorized the system to log onto the social network on behalf of the recommender 105 in order to deliver the recommendation. If the recommender 105 has not configured the system to communicate with the selected network, provided incorrect credentials, the network is busy, or if the system cannot otherwise connect to the selected network to post the recommendation, the system provides 535 an error notification to the recommender 105 explaining the error.

If connection to the selected network is verified, or if the recommender 105 has completed her choice of contact via email or notification, the recommender 105 is allowed to create 540 a custom message to the recommendee 109, which is delivered with the recommendation notification. The process then ends 545 and the recommender 105 is returned to the original application from which she started the recommendation process.

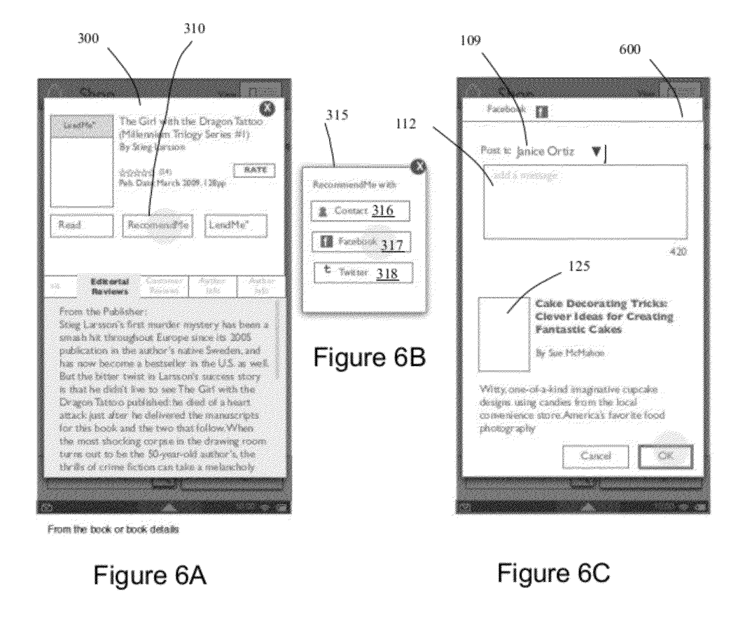

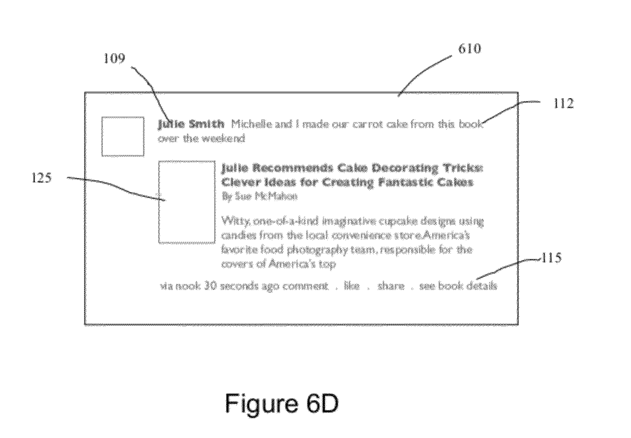

FIGS. 6A-6D illustrate the process of making a recommendation via Facebook™. The process and the elements of FIGS. 6A-6C are similar to those discussed above in regard to FIGS. 2A-2D. One difference is when the recommender 105 selects to transmit the recommendation 110 via Facebook™ 317, the user is provided with a list of her contacts (similar to those illustrated in FIG. 2C) with Facebook™ user IDs in their contact records in the recommender's contact list. Once the recommender 105 chooses the contact with the Facebook™ user ID to become the recommendee 109, the system presents her with user interface 600 in which she can verify the recommendee 109 and create a personal message 112.

FIG. 6D illustrates the Facebook™ news feed 610 containing the recommendation as it appears on recommendee's Facebook™ wall. The newsfeed 610 shows the recommender 109, the personal message 112 and the recommended eBook 125. The text of “see book details” on newsfeed 610 is selectable and contains the URL 115 that will direct the recommendee 109, or any one else that clicks on it, back to the summary of the eBook on the system.

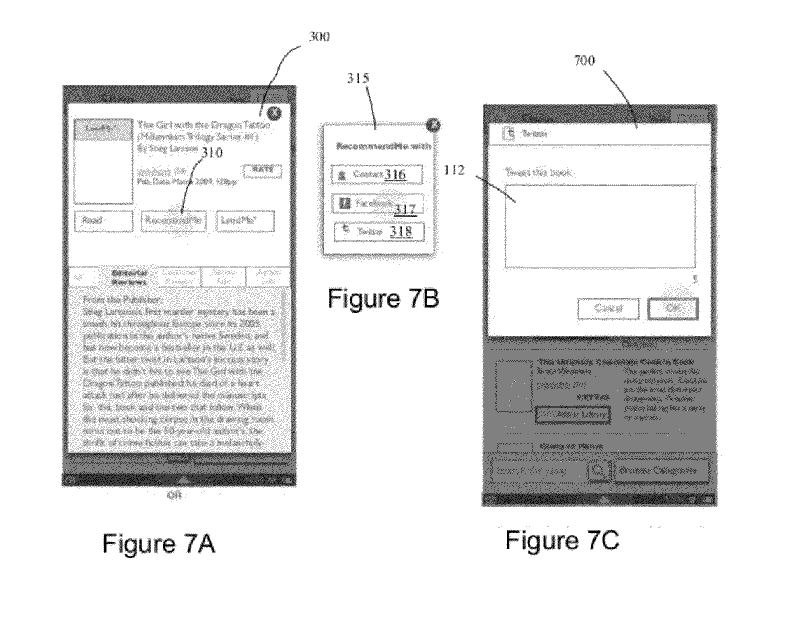

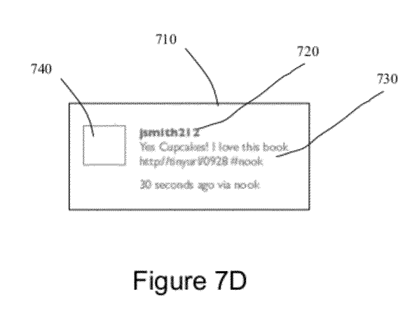

FIGS. 7A-7D illustrate the process of making a recommendation via Twitter™. The process and the elements of FIGS. 7A-7C are similar to those discussed above in regard to FIGS. 2A-2D and 6A-6C. One difference is when the recommender 105 selects to transmit the recommendation 110 via Twitter™ 318, the user does not have to select a particular recommendee. The message can be posted through the recommender's Twitter™ account and is viewable by the recommender's followers and the general public (depending on the settings chosen by the recommender 105). After the recommender 105 has chosen Twitter™ 318, the system presents her with user interface 700 in which she can create a personal message 112. In an alternative embodiment, the personal message can include a reference to a specific contact using the Twitter™ convention “@username” where “username” is the contact's Twitter™ user ID. Putting “@username” at the beginning of the message will direct the message on Twitter™ to the selected contact. The contact's Twitter™ user ID can automatically be retrieved from the recommender's address book as described above in connection with FIGS. 2A-2D.

FIG. 7D illustrates the Twitter™ ‘tweet’ 710 that goes out under the recommender's Twitter™ feed. The tweet 710 shows the recommender 720, the personal message 112 and an icon 740 representing the recommended eBook 125 (e.g., the book cover). The icon 740 is selectable and contains the URL 115 that will direct the user back to the summary of the eBook on the system.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for recommending digital content comprising:
receiving a selection from the user of digital content to be recommended;
presenting the user with the user's contacts list;
receiving a selection of a contact from the user;
transmitting an electronic recommendation to the contact, the electronic recommendation identifying the user and the selected digital content.

2. The method according to claim 1, wherein the digital content is an electronic book.

3. The method according to claim 1, further comprising:
determining identification information for the contact; and
using the identification information to transmit the electronic recommendation to the contact.

4. The method according to claim 3, wherein the identification information is an email address of the contact.

5. The method according to claim 3, wherein the identification information is a social network user ID of the contact.

6. The method according to claim 5, wherein the social network is selected from one of Facebook™ and Twitter™.

7. The method according to claim 1, further comprising:
generating the electronic recommendation, the electronic recommendation including a Uniform Resource Locator (URL).

8. The method according to claim 7, wherein the URL includes a link to a summary of the recommended digital content.

9. The method according to claim 7, wherein the electronic recommendation includes a personal message from the user.

10. The method according to claim 1, further comprising:
receiving a personal message from the user; and
incorporating the personal message into the electronic recommendation.

11. A system for recommending digital content, comprising:
a database server, the database server including an address book database containing users' contact lists; and
an interface server, the interface server providing an interface between the system and a user's local device, the interface server being operable to:
receive a selection from the user of digital content to be recommended,
communicate with the database server and present the user with the user's contacts list from the address book database,
receive a selection a contact from the user, and
transmit an electronic recommendation to the contact, the electronic recommendation identifying the user and the selected digital content.

12. The system according to claim 11, wherein the digital content is an electronic book.

13. The system according to claim 11, wherein the interface server communicates with the database server and is operable to determine identification information for the contact from the address book database, and
wherein the interface server uses the identification information to transmit the electronic recommendation to the contact.

14. The system according to claim 13, wherein the identification information is an email address of the contact stored in the address book database.

15. The system according to claim 13, wherein the identification information is a social network user ID of the contact.

16. The system according to claim 11, wherein the interface server is further operable to generate a Uniform Resource Locator (URL) and generate the electronic recommendation including the URL, wherein the URL includes a link to a summary of the recommended digital content.

17. The system according to claim 11, wherein the database server further comprises a digital locker database, the digital locker database containing digital lockers for users, the digital lockers containing indicia of rights to digital content that users own.

18. A method for recommending digital content comprising:
receiving a selection from the user of digital content to be recommended;
presenting the user with the user's contacts list;
receiving a selection of a contact from the user;
receiving a personalized message from the user;
generating an electronic recommendation, the electronic recommendation identifying the user and including the personalized message and a Uniform Resource Locator (URL), the URL containing a link to a web page related to the selected digital content; and
transmitting the electronic recommendation to the contact.

19. The method according to claim 18, further comprising:
receiving data from the contact in response to the contact employing the URL; and
presenting the contact with the web page, the web page containing a summary of the selected digital content.

19. The method according to claim 18, further comprising:
providing the user with a choice of methods of transmission of the electronic recommendation;
receiving a selection of a method of transmission from the user; and
transmitting the electronic recommendation to the contact using the selected method.

20. The method according to claim 18, further comprising:
determining identification information for the contact; and
using the identification information to transmit the electronic recommendation to the contact.

21. The method according to claim 20, wherein the identification information is an email address of the contact.

22. The method according to claim 20, wherein the identification information is a social network user ID of the contact.
